(19) United States
(12) Patent Application Publication
(10) Pub. No.: US 2022/0095303 A1
(43) Pub. Date: Mar. 24, 2022

(54) SATELLITE SYSTEM FOR ALLOCATING PORTIONS OF A FREQUENCY BAND

(71) Applicant: EOS DEFENSE SYSTEMS USA, INC., Huntsville, AL (US)

(72) Inventors: Anthony J. Colucci, Placitas, NM (US); Karl R. Clausing, San Carlos, CA (US); Larry Rubin, Palo Alto, CA (US)

(21) Appl. No.: 17/025,965

(22) Filed: Sep. 18, 2020

(51) Int. Cl. H04W 72/04; H04B 17/318

(52) U.S. Cl. CPC H04W 72/0453; H04B 17/318; H04W 72/0413

(57) ABSTRACT

In certain aspects, a method comprises receiving radio signals across a frequency band via an antenna, performing spectral measurements on the received radio signals, and determining an unoccupied portion of the frequency band by time and/or orbital position of a satellite based on the spectral measurements. The method also comprises allocating a portion of the frequency band for a link between the satellite and a station by time and/or orbital position of the satellite based on the determined unoccupied portion of the frequency band by time and/or orbital position of the satellite. The method further comprises generating a frequency plan indicating the allocated portion of the frequency band by time and/or orbital position of the satellite.

### BACKGROUND

### Field

Aspects of the present disclosure relate generally to satellites, and, more particularly, to a satellite system for allocating portions of a frequency band.

### Background

A satellite may receive data from another satellite and retransmit the data to a station (e.g., ground station) in a frequency band (e.g., Ka-band spectrum, Ku-band spectrum, etc.). In order to use the frequency-band on a non-interference basis, the satellite and the station need to avoid interfering with other operators with higher priority also using the frequency band.

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

Aspects of the present disclosure relate to a method. The method comprises receiving radio signals across a frequency band via an antenna, performing spectral measurements on the received radio signals, and determining an unoccupied portion of the frequency band by time and/or orbital position of a satellite based on the spectral measurements. The method also comprises allocating a portion of the frequency band for a link between the satellite and a station by time and/or orbital position of the satellite based on the determined unoccupied portion of the frequency band by time and/or orbital position of the satellite. The method further comprises generating a frequency plan indicating the allocated portion of the frequency band by time and/or orbital position of the satellite.

Aspects of the present disclosure relate to a system. The system includes a receiver configured to receive radio signals across a frequency band via an antenna, and a spectral analyzer configured to perform spectral measurements on the received radio signals. The system also includes a resource manager configured to determine an unoccupied portion of the frequency band by time and/or orbital position of a satellite based on the spectral measurements, allocate a portion of the frequency band for a link between the satellite and a station by time and/or orbital position of the satellite based on the determined unoccupied portion of the frequency band by time and/or orbital position of the satellite, and generate a frequency plan indicating the allocated portion of the frequency band by time and/or orbital position of the satellite.

### BRIEF DESCRIPTION OF THE DRAWINGS

FIG. 1A shows an example of a satellite and a station according to certain aspects of the present disclosure.

FIG. 1B shows an example where the station is onboard an aircraft according to certain aspects of the present disclosure.

FIG. 2 shows an exemplary block diagram of the station according to certain aspects of the present disclosure.

FIG. 3 shows an exemplary block diagram of the satellite according to certain aspects of the present disclosure.

FIG. 4A shows an example of occupied portions and unoccupied portions of a frequency band according to certain aspects of the present disclosure.

FIG. 4B shows an example of a portion of the frequency band allocated for transmissions between the satellite and the station according to certain aspects of the present disclosure.

FIG. 4C shows another example of a portion of the frequency band allocated for transmissions between the satellite and the station according to certain aspects of the present disclosure.

FIG. 5 shows an example of a system configured to allocate a portion of the frequency band for a link between the satellite and the station according to certain aspects of the present disclosure.

FIG. 6 shows an example where spectral measurements are performed at the satellite according to certain aspects of the present disclosure.

FIG. 7 shows an example of the system in FIG. 5 extended to multiple stations according to certain aspects of the present disclosure.

FIG. 8 is a flowchart illustrating a method according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

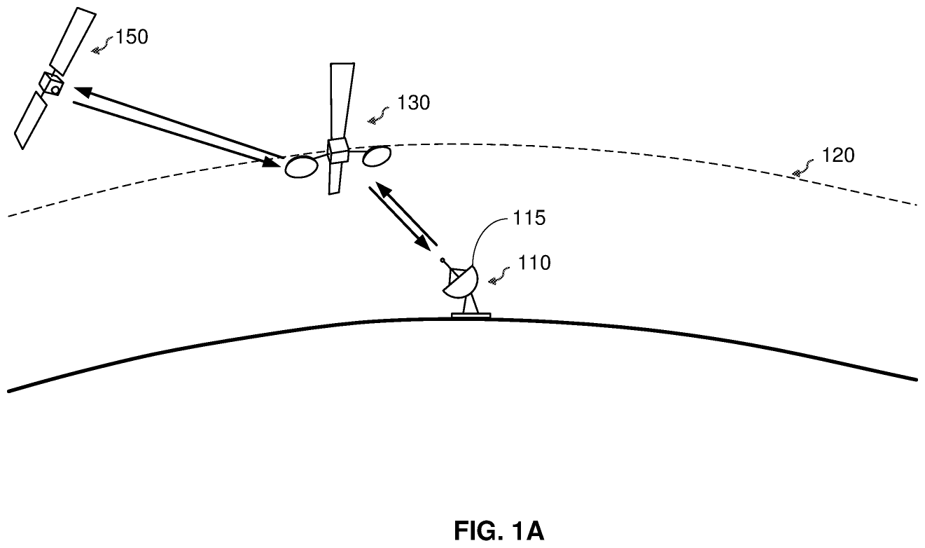

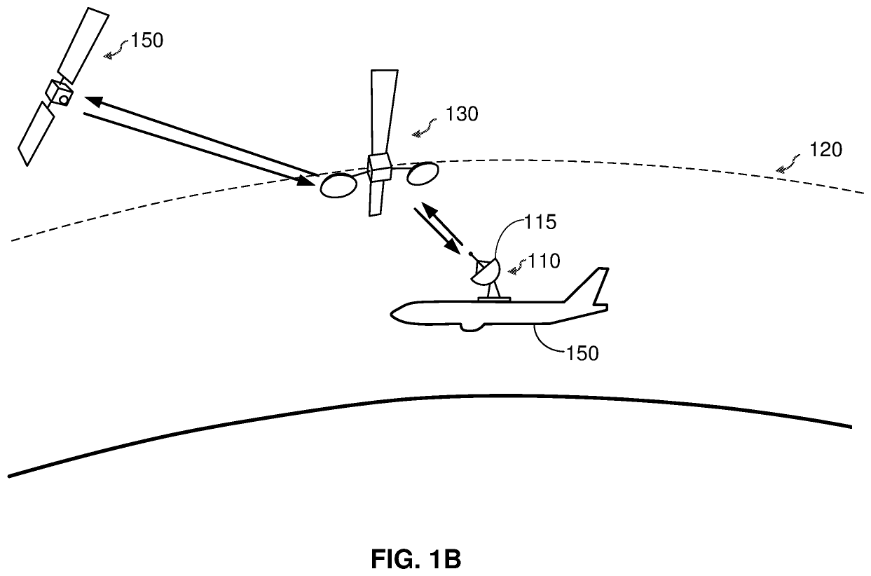

FIG. 1A shows an example of a satellite 130 and a station 110 according to certain aspects. In the example shown in FIG. 1A, the station 110 is a ground station (also referred to as a terrestrial station, or another term). The ground station may be located at a fixed geographical location or may be mounted on a land-based vehicle (i.e., truck, car, etc.) or sea-based vehicle (e.g., ship). However, it is to be appreciated that the station 110 is not limited to a ground station. In other examples, the station 110 may be a station onboard an aircraft that communicates with the satellite 130. In this regard, FIG. 1B shows an example in which the station 110 is onboard an aircraft 150 (e.g., plane). Note that the station 110 is not drawn to scale relative to the aircraft 150 in order to better illustrate the station 110.

The satellite 130 is configured to transmit data to and/or receive data from the station 110. In one example, the satellite 130 is configured to receive data from another satellite 150 and retransmit the received data to the station 110. The satellite 130 may retransmit the data to the station 110 in a frequency band (e.g., the Ka-band spectrum, the Ku-band spectrum, or another band). The satellite 130 may also be configured to receive data from the station 110 and retransmit the data to the other satellite 150. In one example, the satellites 130 and 150 may be part of a space-based relay satellite network. However, it is to be appreciated that the satellites 130 and 150 are not limited to this example.

The station 110 is configured to receive data from and/or transmit data to the satellite 130. In the example in FIG. 1, the satellite 130 travels along an orbital path 120 and establishes a link with the station 110 along a portion of the orbital path 120 in which the satellite 130 is visible to the station 110. The satellite 130 may travel in a Medium Earth Orbit (MEO) or a Low Earth Orbit (LEO). Each time period during which the satellite 130 is visible to the station 110 may be referred to as a “pass.” In this example, the satellite 130 may make one pass over the station 110 during each full orbit of the satellite 130.

The station 110 includes an antenna 115 for transmitting data to and/or receiving data from the satellite 130. The antenna 115 may include a satellite dish, a phased antenna array comprising an array of antenna elements, and/or another type of antenna capable of receiving signals from and/or transmitting signals to the satellite 130. During communication with the satellite 130, the station 110 may steer the antenna 115 such that the direction of the antenna 115 tracks the position of the satellite 130 as the satellite 130 travels along its orbital path 120. In this manner, the station 110 transmits data to and/or receives data in the direction of the satellite 130. In certain aspects, the antenna 115 may be enclosed by a radome (not shown).

The station 110 may function as a gateway that connects the satellite 130 to a terrestrial network (e.g., a local area network, the Internet, a cellular network, a backbone, or a network core, etc.). For the example where the station 110 is onboard an aircraft 150, the station 110 may function as a gateway that connects the satellite to a network onboard the aircraft 150 and/or a terrestrial network linked to the aircraft 150. The station 110 may receive data from the satellite 130 and forward the received data to a network (e.g., terrestrial network and/or network onboard the aircraft 150). The station 110 may also receive data from the network and transmit the data to the satellite 130. The station 110 may communicate with the network via a wired link or a wireless link.

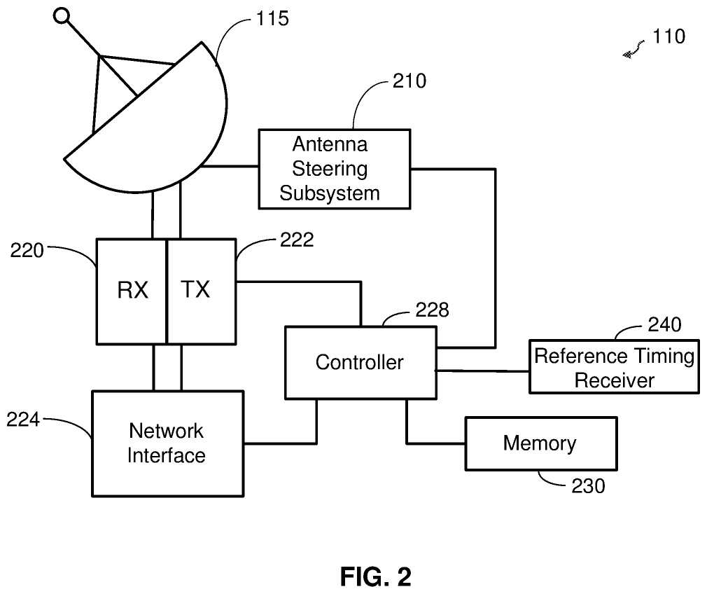

FIG. 2 shows an exemplary block diagram of the station 110 according to certain aspects. As discussed above, the station 110 may be a fixed ground station, a ground station on a land-based vehicle, a station onboard an aircraft, etc. In this example, the station 110 includes an antenna steering subsystem 210, a receiver 220, a transmitter 222, a network interface 224, a controller 228, a memory 230, and a reference timing receiver 240. The controller 228 is configured to control operations of the station 110, as discussed further below. The controller 228 may be implemented with one or more processors (e.g., one or more CPUs), one or more application specific integrated circuits, one or more field programmable gate arrays, or any combination thereof. The memory 230 may store instructions that, when executed by the controller 228, cause the controller 228 to perform the operations of the controller 228 discussed herein. The memory 230 may also store information used by the controller 228 (e.g., orbital information for satellites), as discussed further below.

The antenna steering subsystem 210 is configured to steer the antenna 115 under the control of the controller 228. In one example, the antenna steering subsystem 210 may include a motor mechanically coupled to the antenna 115 to mechanically steer the direction of the antenna 115. For the example where the antenna 115 is implemented with a phased antenna array, the antenna steering subsystem 210 may include a beamformer for electronically steering the direction of the antenna 115. The controller 228 may control the steering by the antenna steering subsystem 210 based on information of the orbital path 120 of the satellite 130 so that the direction of the antenna 115 tracks the position of the satellite 130. The information of the orbital path 120 may be stored in the memory 230.

The receiver 220 is electrically coupled to the antenna 115. The receiver 220 may include amplifiers (e.g., low-noise amplifiers), bandpass filters, frequency down-converters, a baseband processor, etc. To receive data from the satellite 130, the receiver 220 receives, via the antenna 115, radio signals carrying the data from the satellite 130. The receiver 220 may amplify the radio signals, frequency down-convert the radio signals into baseband signals, and demodulate the baseband signals to recover the data.

The transmitter 222 is electrically coupled to the antenna 115. The transmitter 222 may include amplifiers (e.g., power amplifiers), bandpass filters, frequency up-converters, a baseband processor, etc. To transmit data to the satellite 130, the transmitter 222 may modulate signals with the data, frequency up-convert the modulated signals into radio signals, amplify the radio signals, and output the amplified radio signals to the antenna 115 for transmission to the satellite 130.

The network interface 224 (e.g., a network modem) is electrically coupled to the receiver 220 and the transmitter 222. The network interface 224 is configured to connect the station 110 to a network (not shown). The network may include a terrestrial network, a network onboard an aircraft 150, etc. In this regard, the network interface 224 may send data from the satellite 130 recovered by the receiver 220 to the network. The network interface 224 may also receive data from the network and send the data to the transmitter 222 for transmission of the data to the satellite 130. The network interface 224 may receive data from and/or send data to the network via a wired link and/or a wireless link.

The controller 228 is configured to select a portion of a frequency band used by the receiver 220 to receive data from the satellite 130 and/or used by the transmitter 222 to transmit data to the satellite 130, as discussed further below. The frequency band may include any frequency band used for satellite communication. Examples of applicable frequency bands include Very High Frequency (VHF), Ultra High Frequency (UHF), L-band, S-band, K/Ka/Ku-band, Q-band, V-band, C-band, X-band, or any combination thereof.

The reference timing receiver 240 is configured to receive a reference timing signal and send the reference timing signal to the controller 228. The reference timing signal may comprise a Global Positioning System (GPS) based reference timing signal or another reference timing signal. The controller 228 uses the reference timing signal to accurately track time (e.g., time of day). The reference timing receiver 240 may receive the reference timing signal via an antenna, a network, etc.

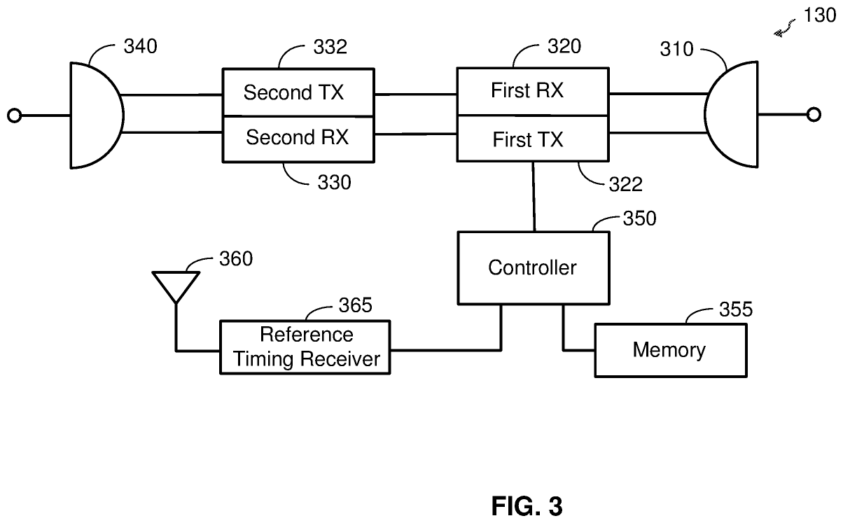

FIG. 3 shows an exemplary block diagram of the satellite 130 according to certain aspects. In this example, the satellite 130 includes a first antenna 310, a first receiver 320, a first transmitter 322, a second receiver 330, a second transmitter 332, a second antenna 340, a controller 350, a memory 355, and a reference timing receiver 365. The controller 350 is configured to control operations of the satellite 130, as discussed further below. The controller 350 may be implemented with one or more processors (e.g., one or more CPUs), one or more application specific integrated circuits, one or more field programmable gate arrays, or any combination thereof. The memory 355 may store instructions that, when executed by the controller 350, cause the controller 350 to perform the operations of the controller 350 discussed herein. The memory 355 may also store information used by the controller 350 (e.g., a frequency plan for the satellite 130).

The first antenna 310 is electrically coupled to the first receiver 320 and the first transmitter 322. The first receiver 320 is configured to receive radio signals from the station 110 via the first antenna 310 and the first transmitter 322 is configured to transmit radio signals to the station 110 via the first antenna 310. The radio signals may carry the data discussed above.

The second antenna 340 is electrically coupled to the second receiver 330 and the second transmitter 332. The second receiver 330 is configured to receive radio signals from another satellite (e.g., satellite 150 shown in FIGS. 1A and 1B) via the second antenna 340 and the second transmitter 332 is configured to transmit radio signals to the other satellite via the second antenna 340. The radio signals may carry the data discussed above.

In the example in FIG. 3, the first transmitter 322 is electrically coupled to the second receiver 330 for relaying data from the other satellite (e.g., satellite 150) to the station 110. For example, to relay data from the other satellite to the station 110, the second receiver 330 receives radio signals carrying the data from the other satellite via the second antenna 340 and sends the received signals to the first transmitter 322 for retransmission to the station 110. The second receiver 330 may amplify the received signals and/or translate the frequencies of the received signals before sending the received signals to the first transmitter 322. The first transmitter 322 then transmits the received signals to the station 110 via the first antenna 310. The first transmitter 322 may translate the frequencies of the signals before transmitting the signals so that the signals are transmitted on a selected portion of a frequency band, as discussed further below. The first transmitter 322 may also amplify the signals before transmitting the signals.

In the example in FIG. 3, the first receiver 320 is electrically coupled to the second transmitter 332 for relaying data from the station 110 to the other satellite (e.g., satellite 150). To relay data from the station 110 to the other satellite, the first receiver 320 receives radio signals carrying the data from the station 110 via the first antenna 310 and sends the received signals to the second transmitter 332 for retransmission to the other satellite. The first receiver 320 may receive the radio signals from the station 110 on a selected portion of a frequency band. The first receiver 320 may amplify the received signals and/or translate the frequencies of the received signals before sending the received signals to the second transmitter 332. The second transmitter 332 then transmits the received signals to the other satellite via the second antenna 340. The second transmitter 332 may translate the frequencies of the signals and/or amplify the signals before transmitting the signals to the other satellite.

The controller 350 is configured to select the portion of the frequency band used by the first transmitter 322 to transmit data to the station 110 and/or the portion of the frequency band used by the first receiver 320 to receive data from the station 110. As discussed further below, a frequency plan may be uploaded to the satellite 130 (e.g., from the station 110 or another station) and the controller 350 may select a portion of the frequency plan for transmitting data to and/or receiving data from the station 110 according to the uploaded frequency plan.

The reference timing receiver 365 is configured to receive a reference timing signal via an antenna 360 and send the reference timing signal to the controller 350. The reference timing signal may comprise a GPS based reference timing signal or another reference timing signal. The controller 350 uses the reference timing signal to accurately track time (e.g., time of day). In certain aspects, the reference timing receiver 365 on the satellite 130 and the reference timing receiver 240 at the station 110 may receive the same type of reference timing signal (e.g., GPS based reference timing signal) to enhance timing synchronization between the satellite 130 and the station 110.

As discussed above, the satellite 130 may transmit data to and/or receive data from the station 110 using a portion of a frequency band. As discussed above, the frequency band may include any frequency band used for satellite communication. Examples of applicable frequency bands include VHF, UHF, L-band, S-band, K/Ka/Ku-band, Q-band, V-band, C-band, X-band, or any combination thereof.

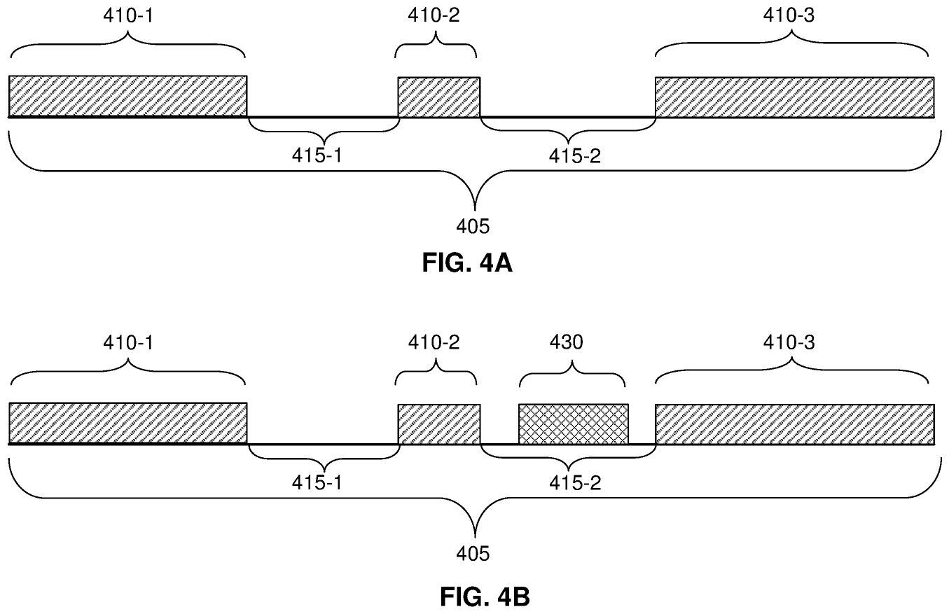

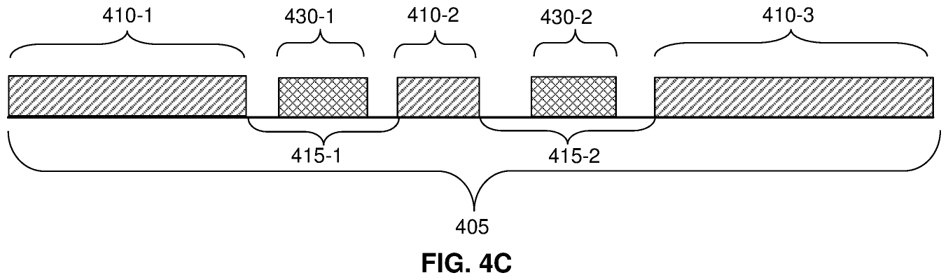

In order to use the frequency band on a non-interference basis, the satellite 130 and the station 110 need to avoid interfering with other operators with higher priority also using the frequency band. In this regard, FIG. 4A shows an example of a frequency band 405 that the satellite 130 and the station 110 use on a non-interference basis. In FIG. 4A, frequency is in the horizontal direction. FIG. 4A shows an example of occupied portions 410-1 to 410-3 of the frequency band 405 that are being used by other operators with higher priority. FIG. 4A also shows an example of unoccupied portions 415-1 and 415-2 of the frequency band 405 that are available to the satellite 130 and the station 110 for transmissions between the satellite 130 and the station 110. To avoid interfering with the higher priority operators (e.g., licensed operators), the satellite 130 may transmit data to the station 110 in the unoccupied portions 415-1 and 415-2 of the frequency band 405.

In this regard, FIG. 4B shows an example in which the satellite 130 transmits data to the station 110 in a portion 430 of the frequency band 405 that is located within an unoccupied portion 415-2 of the frequency band 405 to avoid interference. The width of the portion 430 of the frequency band 405 used by the satellite 130 and the station 110 may vary, for example, depending on a desired data bandwidth for transmissions between the satellite 130 and the station 110, the amount of the frequency band that is available, and/or one or more other factors. In one example, the satellite 130 may transmit data to the station 110 on channels or frequency carriers within the portion 430 of the frequency band 405. However, it is to be appreciated that the satellite 130 is not limited to this example.

In the example shown in FIG. 4B, the portion 430 of the frequency band 405 used by the satellite 130 and the station 110 is contiguous. However, it is to be appreciated that this need not be the case. For example, FIG. 4C shows an example in which the portion 430 of the frequency band 405 used by the satellite 130 and the station 110 is non-contiguous. In this example, the portion 430 of the frequency band 405 includes a first sub-portion 430-1 and a second sub-portion 430-2 separated by an occupied portion 410-2 of the frequency band 405. Thus, the portion 430 of the frequency band 405 used by the satellite 130 and the station 110 may have a variable width, and may be contiguous or non-contiguous.

A challenge with avoiding interference is that the portions of the frequency band used by other operators change over time and geographical area. As a result, the unoccupied portions of the frequency band available to the satellite 130 and the station 110 are dynamic (e.g., may change over time and/or orbital position of the satellite 130). Accordingly, systems and methods for dynamically changing the transmit/receive frequency of the satellite 130 and the station 110 to adapt to changes in the available portions of the frequency band are desirable.

To address the above challenge, aspects of the present disclosure provide systems and methods for dynamically allocating a portion of the frequency band for the link between the satellite 130 and the station 110 to adapt to changes in the available portions of the frequency band over time and/or orbital position of the satellite 130, as discussed further below.

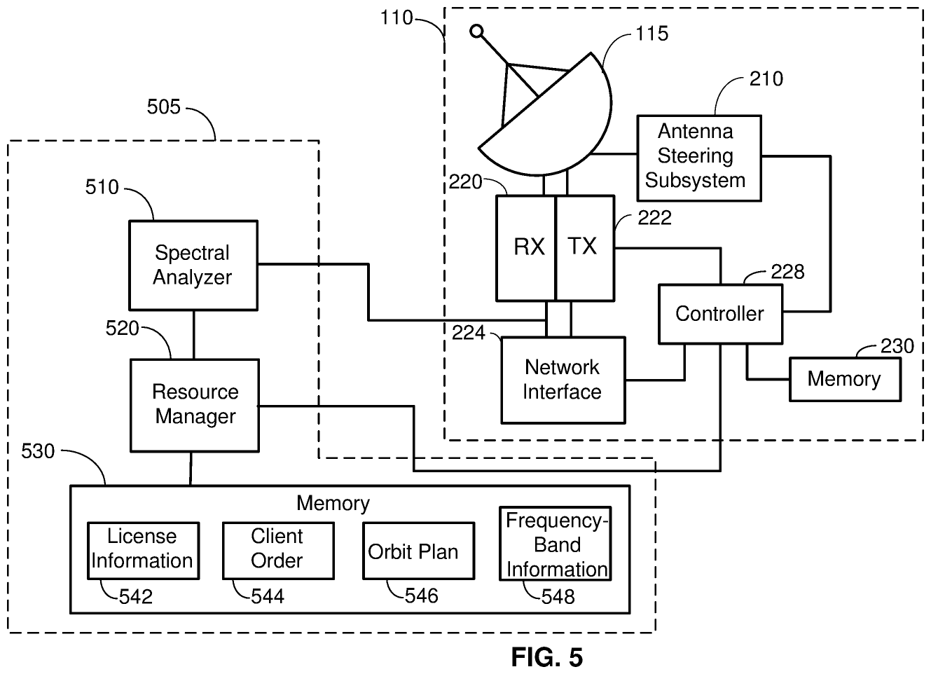

FIG. 5 shows an example of a system 505 configured to allocate a portion of the frequency band for the link between the satellite 130 and the station 110 according to certain aspects. The system 505 includes a spectral analyzer 510, a resource manager 520, and a memory 530. The spectral analyzer 510 is coupled to the station receiver 220, and the resource manager 520 is coupled to the spectral analyzer 510, the station controller 228, and the memory 530. The resource manager 520 may be implemented with one or more processors (e.g., one or more CPUs), one or more application specific integrated circuits, one or more field programmable gate arrays, or any combination thereof.

The memory 530 may store instructions that, when executed by the resource manager 520, cause the resource manager 520 to perform the operations of the resource manager 520 discussed herein. The memory 530 also stores information used by the resource manager 520. The information may include license information 542, a client order 544, an orbit plan 546, and frequency-band information 548, each of which is discussed in greater detail below. It is to be appreciated that the memory 530 may be implemented with multiple memory devices (e.g., random access memory, flash memory, magnetic disks, optical disks, hard drives, or any combination thereof).

In operation, the receiver 220 receives radio signals across the frequency band via the antenna 115 or another antenna (not shown), and sends the received radio signals to the spectral analyzer 510. In certain aspects, the receiver 220 digitizes the received radio signals and sends the digitized radio signals to the spectral analyzer 510 for spectral analysis.

The spectral analyzer 510 measures one or more properties of the radio signals across the frequency band. For example, the spectral analyzer 510 may measure signal strength, power and/or energy across the frequency band. The spectral analyzer 510 sends the spectral measurement to the resource manager 520. As discussed further below, the resource manager 520 uses the spectral measurement to determine occupied portions of the frequency band.

In certain aspects, the receiver 220 receives radio signals across the frequency band via the antenna 115 and sends the received radio signals to the spectral analyzer 510 as the antenna 115 tracks the position of the satellite 130. For example, the receiver 220 may receive the radio signals across the frequency band via the antenna 115 concurrently with the receiver 220 receiving data from the satellite 130 via the antenna 115. Thus, in these aspects, the spectral analyzer 510 measures radio signals received in the direction of the satellite 130, and therefore measures the frequency band in the direction of the satellite 130. In these aspects, the receiver 220 may continuously receive radio signals across the frequency band via the antenna 115 as the antenna 115 tracks the position of the satellite 130 and send the received radio signals to the spectral analyzer 510, or the receiver 220 may receive radio signals across the frequency band via the antenna 115 at regular intervals as the antenna 115 tracks the position of the satellite 130 and send the received radio signals to the spectral analyzer 510.

It is to be appreciated that the receiver 220 is not limited to receiving the radio signals across the frequency band via the antenna 115. In other implementations, the receiver 220 may receive radio signals across the frequency band via another antenna (not shown), which may also track the orbital position of the satellite 130.

In certain aspects, the antenna 115 operates at an elevation of at least 15° when tracking the position of the satellite 130. Thus, in these aspects, the spectral analyzer 510 measures the frequency band at an elevation of at least 15°. As a result, the spectral analyzer 510 may ignore signals at elevations below 15°. This may eliminate a large portion of potential interference with, for example, terrestrial networks that transmit signals at elevations below 15°.

As discussed above, the spectral analyzer 510 may receive radio signals from the receiver 220 as the antenna 115 or another antenna tracks the position of the satellite 130. In these aspects, the spectral analyzer 510 may measure the frequency band as the antenna 115 or another antenna tracks the position of the satellite 130 using the radio signals received from the receiver 220. The spectral analyzer 510 may send the spectral measurements to the resource manager 520, which may catalog the spectral measurements and store the cataloged spectral measurements in the memory 530. For example, the resource manager 520 may catalog each spectral measurement by time (e.g., time of day), orbital position of the satellite 130, and/or location of the station 110. In this example, time (e.g., time of day) may refer to the time (e.g., time of day) that the radio signals used in a spectral measurement are received by the station 110, and orbital position may refer to the orbital position of the satellite 130 at the time the radio signals used in a spectral measurement are received by the station 110. The resource manager 520 may determine the orbital position of the satellite 130 for each spectral measurement based on the orbit plan 546 of the satellite 130 stored in the memory 530. The resource manager 520 may determine the time for each spectral measurement using time derived from a reference timing signal.

In certain aspects, the spectral analyzer 510 may measure the frequency band over multiple passes of the satellite 130 over the station 110. Thus, in these aspects, the spectral measurements stored in the memory 530 may cover multiple passes of the satellite 130.

The resource manager 520 may process the spectral measurements in the memory 530 to identify a portion of the frequency band that is unoccupied and therefore available for the link between the satellite 130 and the ground station 110. For example, the resource manager 520 may identify a portion of the frequency band as being unoccupied from a spectral measurement if the measured signal strength, power or energy at frequencies within the portion of the frequency band is below a threshold. Conversely, the resource manager 520 may identify a portion of the frequency band as being occupied if the measured signal strength, power or energy at frequencies within the portion of the frequency band is above the threshold. Since the spectral measurements are cataloged by time (e.g., time of day) and/or orbital position of the satellite 130, the resource manager 520 may process spectral measurements for different times and/or orbital positions of the satellite 130 to identify a unoccupied portion of the frequency band for each of the different times and/or orbital positions of the satellite 130. For example, the resource manager 520 may identify the unoccupied portion of the frequency band for each of the different times and/or orbital positions by identifying a portion of the frequency band for each of the different times and/or orbital positions within which the measured signal strength, power or energy is below the threshold. The resource manager 520 may store the information on the unoccupied portion of the frequency band for each of the different times and/or orbital positions of the satellite 130 in the memory 530 as part of the frequency-band information 548. This information allows the resource manager 520 to track changes in the unoccupied portion of the frequency band over time (e.g., time of day) and/or orbital position of the satellite 130.

In certain aspects, the resource manager 520 correlates each identified occupied portion of the frequency band with the license information 542 to determine whether the occupied portion of the frequency band is being used by a licensed operator. In these aspects, the license information 542 may include a list of operators licensed to use the frequency band by a regulatory body (e.g., FCC, ITU, etc.) and a portion of the frequency band licensed to each licensed operator. The resource manager 520 may determine whether an occupied portion of the frequency band is being used by a licensed operator by determining whether the occupied portion is in a portion of the frequency band licensed to one of the licensed operators in the license information 542. If the occupied portion of the frequency band is in a portion of the frequency band licensed to one of the licensed operators, then the resource manager 520 determines that the occupied portion is being used by a licensed operator. In this case, the resource manager 520 avoids allocating the occupied portion of the frequency band for the link between the satellite 130 and the station 110 to avoid interfering with the licensed operator. If the occupied portion of the frequency band is in a portion of the frequency band that is not licensed to one of the licensed operators, then the resource manager 520 may determine that the occupied portion of the frequency band is being used by an unlicensed operator. The resource manager 520 may store the information on occupied portions of the frequency band being used by licensed operators and occupied portions of the frequency band being used by unlicensed operators in the memory 530 as part of the frequency-band information 548.

In certain aspects, the resource manager 520 generates a frequency plan for the link between the satellite 130 and the station 110 based on, for example, the frequency-band information 548, the orbit plan 546, and the client order 544. The client order 544 may be an order from one or more clients to have the satellite 130 relay data for the one or more clients. The client order 544 may indicate the amount of client data to be relayed and/or a desired data bandwidth for the client data. In this example, the resource manager 520 may determine an amount of the frequency band (i.e., frequency bandwidth) to be allocated for the link based on the client order 544. For example, the resource manager 520 may determine a larger amount of the frequency band if the client order 544 indicates a larger amount of client data to be relayed and/or a higher data bandwidth. For the example in which the client order 544 indicates a data bandwidth for the client data, the resource manager 520 may determine the amount of the frequency band needed to achieve the data bandwidth.

After determining the amount of the frequency band needed for the link, the resource manager 520 may determine which portion of the frequency band to allocate for the link based on the frequency-band information 548. For example, the resource manager 520 may determine an unoccupied portion of the frequency band based on the frequency-band information and allocate a portion of the frequency band within the unoccupied portion of the frequency band for the link. As discussed above, the frequency-band information 548 may indicate which portion of the frequency band is unoccupied for different times and/or orbital positions of the satellite 130. In this case, the resource manager 620 may use this information to allocate a portion of the frequency band for the link by time and/or orbital position. For example, the resource manager 520 may allocate a portion of the frequency band for each of the different times and/or orbital positions based on the portion of the frequency band that is unoccupied for that time and/or orbital position, as indicated by the frequency-band information 548. The resource manager 520 may set the width (i.e., frequency bandwidth) of an allocated portion of the frequency band based on the determined amount of the frequency band needed to achieve the data bandwidth discussed above.

In certain aspects, if the unoccupied portion of the frequency band for a certain time and/or orbital position is not enough to achieve a desired data bandwidth (e.g., as indicated in the client order 544), then the resource manager 520 may examine an occupied portion of the frequency band being used by an unlicensed operator (e.g., as indicated in the frequency-band information 548) for possible use. For example, the resource manager 520 may compare the signal strength, power or energy at frequencies within the occupied portion of the frequency band being used by the unlicensed operator with an interference threshold. If the signal strength, power or energy at frequencies within the occupied portion of the frequency band being used by the unlicensed operator is below the interference threshold, then the resource manager 520 may allocate the occupied portion of the frequency band for the link. If the signal strength, power or energy at frequencies within the occupied portion of the frequency band being used by the unlicensed operator is above the interference threshold, then the resource manager 520 may not allocate the occupied portion of the frequency band for the link. The interference threshold may be set to an interference level that is tolerable for the link. It is to be appreciated that the interference threshold is different from the threshold used to determine whether a portion of the frequency band is occupied. In this example, the portion of the frequency band allocated to the link between the satellite 130 and the station 110 by the resource manager 520 may include a combination of an unoccupied portion of the frequency band and an occupied portion of the frequency band that is being used by an unlicensed operator for cases where the amount of frequency band needed to achieve a desired bandwidth exceeds the unoccupied portion of the frequency band.

After allocating the portion of the frequency band for the link by time and/or orbital position, the resource manager 520 generates a frequency plan for the link. The frequency plan may indicate the portion of the frequency band allocated for the link by time and/or orbital position.

For the case where the allocated portion of the frequency band is the same for consecutive times (e.g., times of day), the frequency plan may indicate that the portion of the frequency band is allocated for a time period including the consecutive times. The frequency plan may indicate the period of time by a start time and an end time.

For the case where the allocated portion of the frequency band is the same for consecutive orbital positions of the satellite 130, the frequency plan may indicate that the portion of the frequency band is allocated for a portion of the satellite's orbital path 120 including the consecutive orbital positions. The frequency plan may indicate the portion of the orbital path 120 by a start position and end position.

The frequency plan may indicate an allocated portion of the frequency band by indicating the frequencies at the boundaries of the allocated portion of the frequency band. For the example in which the satellite 130 transmits data to the station 110 on channels or frequency carriers, the frequency plan may indicate an allocated portion of the frequency band by indicating the channels or frequency carriers within the allocated portion of the frequency band.

After generating the frequency plan for the link between the satellite 130 and the station 110, the resource manager 520 may send the frequency plan to the station controller 228. The controller 228 may store a copy of the frequency plan in the memory 230. The frequency plan indicates to the station 110 which portion of the frequency band to use to receive data from the satellite 130, as discussed further below.

The resource manager 520 also uploads the frequency plan to the satellite 130. The resource manager 520 may upload the frequency plan to the satellite 130 via the station 110 or another station. For the example in which the frequency plan is uploaded from the station 110, the controller 228 may send the frequency plan to the transmitter 222 for transmission to the satellite 130 via the antenna 115. The resource manager 520 may upload the frequency plan to the satellite 130 at a scheduled time for the frequency plan upload.

Referring to FIG. 3, the first receiver 320 at the satellite 130 may receive the frequency plan via the first antenna 310 from the station 110 or another station, and send the received frequency plan to the controller 350. The controller 350 may store the frequency plan in the memory 355. The controller 350 may then execute the frequency plan based on the orbital position of the satellite 130 and/or time (e.g., time of day), as discussed further below.

After receiving the frequency plan, the controller 350 may select the portion of the frequency band used for the link to the station 110 based on the orbital position of the satellite 130 and/or time (e.g., time of day) using the frequency plan. For example, the controller 350 may determine the current orbital position of the satellite 130 and/or time, and then determine the portion of the frequency band allocated to the link for the determined current orbital position and/or time using the frequency plan. The controller 350 then directs the first transmitter 322 to transmit data to the station 110 using the allocated portion of the frequency band. For example, the first transmitter 322 may transmit radio signals carrying the data on one or more channels or carriers located within the allocated portion of the frequency band.

In certain aspects, the controller 350 determines the allocated portion of the frequency band for the current orbital position and/or time by looking up the portion of the frequency band for the current orbital position and/or time in the frequency plan, and using the looked-up portion of the frequency band. For the example in which the frequency plan indicates a time period and/or a portion of the satellite's orbital path 120 for a portion of the frequency band, the controller 350 may use the portion of the frequency band for the link if the current time is within the indicated time period and/or the current orbital position of the satellite 130 is within the indicated portion of the satellite's orbital path 120.

Referring to FIG. 2, at the station 110, the controller 228 may select the portion of the frequency band for reception of the data transmitted by the satellite 130 based on the orbital position of the satellite 130 and/or time using the frequency plan. For example, the controller 228 may determine the current orbital position and/or time, and then determine the portion of the frequency band allocated for the link for the determined current orbital position and/or time using the frequency plan. The controller 228 then directs the receiver 220 to receive the data from the satellite 130 on the allocated portion of the frequency band.

In certain aspects, the controller 228 determines the allocated portion of the frequency band for the current orbital position and/or time by looking up the portion of the frequency band for the current orbital position and/or time in the frequency plan, and using the looked-up portion of the frequency band. For the example in which the frequency plan indicates a time period and/or a portion of the satellite's orbital path 120 for a portion of the frequency band, the controller 228 may use the portion of the frequency band for reception if the current time is within the indicated time period and/or the current orbital position of the satellite 130 is within the indicated portion of the satellite's orbital path 120.

Thus, the frequency plan according to aspects of the present disclosure allow the satellite 130 and the station 110 to adapt the portion of the frequency band used for the link between the satellite 130 and the station 110 to changes in the available portions of the frequency band over time and orbital position of the satellite 130.

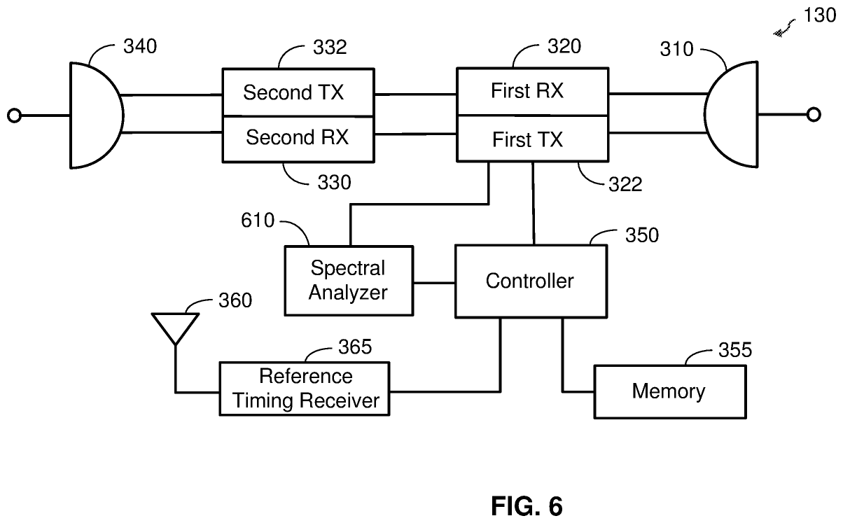

It is to be appreciated that the present disclosure is not limited to receiving radio signals across the frequency band for spectral analysis at the station 110. In another example, the first receiver 320 on the satellite 130 may receive radio signals across the frequency band via the first antenna 130. In this example, a spectral analyzer onboard the satellite 130 may perform spectral measurements on the received radio signals. In this regard, FIG. 6 shows an example in which the satellite 130 includes an onboard spectral analyzer 610. In this example, the onboard spectral analyzer 610 is coupled to the first receiver 320 to receive the radio signals. The onboard spectral analyzer 610 performs spectral measurements on the received radio signals and sends the spectral measurements to the controller 350. The controller 350 may store the spectral measurements in the memory 355 and/or send the measurements to the first transmitter 322 for transmission to the station 110 or another station that forwards the spectral measurement to the resource manager 520. In certain aspects, the controller 350 may catalog the spectral measurements by time and/or orbital position before sending the measurements to the resource manager 520.

Alternately, the satellite 130 may digitize the received radio signals and transmit the digitized radio signals to the station 110 or another station that forwards the spectral measurements to the spectral analyzer 510. In this example, the spectral analyzer 510 may perform spectral measurements on the received radio signals. In either case, the spectral measurements may be cataloged by time and/or orbital position of the satellite 130.

The resource manager 520 may then use the spectral measurements cataloged by time and/or orbital position to identify an unoccupied portion of the frequency band by time and/or orbital position, as discussed above. The resource manager 520 may then allocate a portion of the frequency band for the link by time and/or orbital position based on the identified unoccupied portion of the frequency band by time and/or orbital position, and generate a frequency plan indicating the allocated portion of the frequency band by time and/or orbital position. The generated frequency plan may then be uploaded to the satellite 130 via the station 110 or another station. Alternatively, the frequency plan may be generated at the satellite 130 by the controller 350. In this example, the controller 350 may generate the frequency plan by performing the operations of the resource manager 520 discussed above.

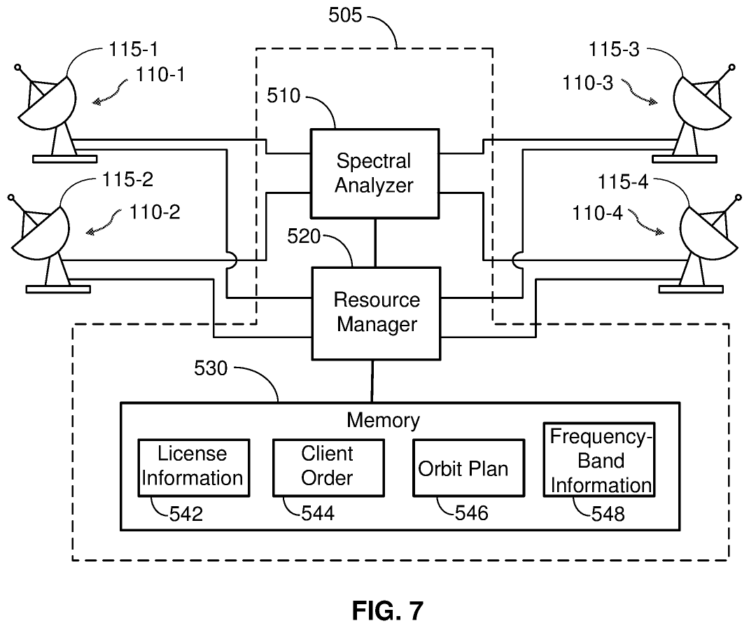

Aspects of the present disclosure discussed above may be extended to allocate portions of the frequency band for downlinks to multiple stations (e.g., multiple ground stations located at different geographical locations). In this regard, FIG. 7 shows an example of the system 505 coupled to multiple stations 110-1 to 110-4 (e.g., multiple ground stations located at different geographical locations). Each of the stations 110-1 to 110-4 may be implemented with the exemplary station 110 shown in FIG. 2 (i.e., each of the stations 110-1 to 110-4 may be a separate instance of the exemplary station 110). It is to be appreciated that the number of stations 110-1 to 110-4 shown in FIG. 7 is exemplary, and that the system 505 may be coupled to a variable number of satellites.

In certain aspects, the satellite 130 may communicate with each of the stations 110-1 to 110-4 during each orbit (e.g., the satellite 130 may communicate with each of the stations 110-1 to 110-4 along a different portion of its orbital path 120). The stations 110-1 to 110-4 may also communicate with one or more other satellites. In this example, the resource manager 520 may generate a frequency plan for each station and upload the frequency plans to the satellite 130 (e.g., via one or more of the stations 110-1 to 110-4), as discussed further below.

In operation, the receiver at each of the stations 110-1 to 110-4 receives, via the respective antenna 115-1 to 115-4, radio signals across the frequency band when the satellite is visible to the station. The antenna 115-1 to 115-4 at each station 110-1 to 110-4 tracks the position of the satellite 130 when the satellite 130 is visible. Thus, the radio signals received at each station 110-1 to 110-4 are received in the direction of the satellite 130. The receiver at each of the stations 110-1 to 110-4 may continuously receive radio signals across the frequency band or receive radio signals across the frequency band at regular intervals as the respective antenna 115-1 to 115-4 tracks the satellite 130. Each station 110-1 to 110-4 may send the respective received radio signals to the spectral analyzer 510 for spectral analysis. In one example, each station 110-1 to 110-4 may digitize the respective radio signals before sending the respective radio signals to the spectral analyzer 510.

The spectral analyzer 510 performs spectral measurements on the radio signals received from each station 110-1 to 110-4. For example, for the radio signals received from each station 110-1 to 110-4, the spectral analyzer 510 may measure signal strength, power, and/or energy across the frequency band. The spectral measurements for each station 110-1 to 110-4 may be cataloged by time, orbital position and/or location of the station and stored in the memory 530 by the resource manager 520.

For each station 110-1 to 110-4, the resource manager 520 may process the spectral measurements for the station for different times and/or orbital positions of the satellite 130 to determine an unoccupied portion of the frequency band for each of the different times and/or orbital positions. Thus, for each of the stations 110-1 to 110-4, the resource manager 520 determines the unoccupied portion of the frequency band for the station by time and/or orbital position of the satellite 130. This allows the resource manager 520 to track the unoccupied portion of the frequency band at each station 110-1 to 110-4 over time and/or orbital position of the satellite 130.

For each station 110-1 to 110-4, the resource manager 520 may allocate a portion of the frequency band for the link between the satellite 130 and the station by time and/or orbital position based on the determined unoccupied portion of the frequency band for the station by time and/or orbital position. For example, the portion of the frequency band allocated for each link may be located within the respective unoccupied portion of the frequency band to avoid interference with operators with higher priority (e.g., licensed operators).

For each station 110-1 to 110-4, the resource manager 520 generates a respective frequency plan indicating the allocated portion of the frequency band for the link between the satellite 130 and the station by time and/or orbital position. The resource manager 520 may then upload the frequency plans for the stations 110-1 to 110-4 to the satellite 130. For example, the resource manager 520 may send the frequency plans to a station (e.g., one of the stations 110-1 to 110-4) for transmission to the satellite 130. The frequency plans for the stations 110-1 to 110-4 may be different since the frequency plan for each station reflects the radio environment at the location of that station, which varies from station to station.

Thus, in this example, the frequency plans are uploaded to the satellite 130 where each frequency plan is for a link between the satellite and the respective one of the stations 110-1 to 110-4. The first receiver 320 at the satellite 130 may receive the frequency plans via the first antenna 310. The controller 350 at the satellite 130 stores the uploaded frequency plans in the memory 355. The controller 350 executes the frequency plan for each station 110-1 to 110-4 when the satellite 130 is visible to the station. More particularly, for each station 110-1 to 110-4, the controller 350 determines the current time and/or orbital position, determines the allocated portion of the frequency band for the determined time and/or orbital position using the respective frequency plan, and directs the first transmitter 322 to transmit data to the station using the allocated portion of the frequency band.

The resource manager 520 may also send the frequency plan for each station 110-1 to 110-4 to the respective station. The controller at each station 110-1 to 110-4 may then select the portion of the frequency band for reception of data from the satellite 130 based on the orbital position of the satellite 130 and/or time using the respective frequency plan. The controller at each station may perform the operations of the controller 228 discussed above using the respective frequency plan.

As discussed above, the stations 110-1 to 110-4 may also communicate with one or more other satellites. In this case, the system 505 may generate frequency plans for the one or more other satellites in a similar manner as the frequency plans for the satellite 130 discussed above according to various aspects.

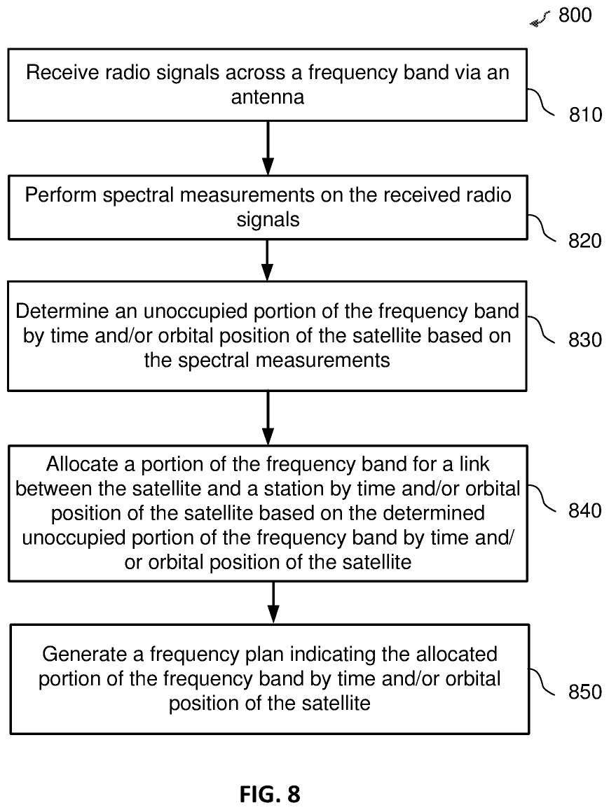

FIG. 8 is a flowchart illustrating an exemplary method 800 according to certain aspects of the present disclosure.

At block 810, radio signals are received across a frequency band via an antenna. In one example, the radio signals may be received at the station 110 via the antenna 115 or another antenna. The station 110 may be a ground station or a station onboard an aircraft 150. In another example, the radio signals may be received at the satellite 130 via the first antenna 310 or another antenna.

At block 820, spectral measurements are performed on the received radio signals. For example, the spectral measurements may be performed by the spectral analyzer 510 or the spectral analyzer 610. The spectral measurements may comprise measured signal strength, power, and/or energy across the frequency band.

At block 830, an unoccupied portion of the frequency band is determined by time and/or orbital position of a satellite based on the spectral measurements. For example, the unoccupied portion of the frequency band may be determined by the resource manager 520.

At block 840, a portion of the frequency band is allocated for a link between the satellite and a station by time and/or orbital position of the satellite based on the determined unoccupied portion of the frequency band by time and/or orbital position of the satellite. For example, the portion of the frequency band for the link may be allocated by resource manager 520.

At block 850, a frequency plan is generated indicating the allocated portion of the frequency band by time and/or orbital position of the satellite. For example, the frequency plan may be generated by the resource manager 520.

In certain aspects, the station may be a ground station and the antenna may point at an elevation of at least 15 degrees while the radio signals are being received via the antenna.

In certain aspects, the antenna may track the orbital position of the satellite (e.g., using the antenna steering subsystem 210). In these aspects, receiving the radio signals across the frequency band via the antenna may include receiving the radio signals across the frequency band via the antenna as the antenna tracks the orbital position of the satellite.

In certain aspects, the method 800 may optionally include receiving data at the station from the satellite via the antenna concurrently with receiving the radio signals across the frequency band via the antenna. For example, the data and radio signal may be received concurrently by the receiver 220 via the antenna 115.

In certain aspects, the method 800 may optionally include uploading the generated frequency plan to the satellite. For example, the frequency plan may be uploaded to the satellite via the station or another station.

In certain aspects, the method 800 may optionally include determining an occupied portion of the frequency band by time and/or orbital position of the satellite based on the spectral measurements, and correlating the determined occupied portion of the frequency band by time and/or orbital position with license information, wherein the license information indicates one or more portions of the frequency band licensed to one or more operators. The occupied portion of the frequency band may be determined by the resource manager 520, and the correlation may be performed by the resource manager 520. The license information may correspond to the license information 542 stored in the memory 530.

In certain aspects, the spectral measurements comprise measured signal strength, power, and/or energy across the frequency band. In these aspects, determining the unoccupied portion of the frequency band by time and/or orbital position of the satellite based on the spectral measurements may include comparing the measured signal strength, power, and/or energy across the frequency band with a threshold, and determining the unoccupied portion of the frequency band by time and/or orbital position of the satellite based on the comparison. The comparison may be performed by the resource manger 520. In certain aspects, determining the unoccupied portion of the frequency band by time and/or orbital position of the satellite based on the comparison may include determining a portion of the frequency band within which the signal strength, power, and/or energy across the frequency band is below the threshold.

In certain aspects, the method 800 may optionally include determining a data bandwidth based on a client order, and determining a frequency bandwidth that supports the determined data bandwidth, wherein allocating the portion of the frequency band for the link between the satellite and the station by time and/or orbital position of the satellite is based also on the determined frequency bandwidth. The determination of the frequency bandwidth may be performed by the resource manager 520, and the client order may correspond to the client order 544 stored in the memory 530.

Any reference to an element herein using a designation such as “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure Likewise, the term “aspects” does not require that all aspects of the disclosure include the discussed feature, advantage or mode of operation.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A method, comprising:
receiving radio signals across a frequency band via an antenna;
performing spectral measurements on the received radio signals;
determining an unoccupied portion of the frequency band by time and/or orbital position of a satellite based on the spectral measurements;
allocating a portion of the frequency band for a link between the satellite and a station by time and/or orbital position of the satellite based on the determined unoccupied portion of the frequency band by time and/or orbital position of the satellite; and
generating a frequency plan indicating the allocated portion of the frequency band by time and/or orbital position of the satellite.

2. The method of claim 1, wherein the frequency band comprises VHF, UHF, L-band, S-band, K/Ka/Ku-band, Q-band, V-band, C-band, X-band, or any combination thereof.

3. The method of claim 1, wherein the radio signals are received at the station.

4. The method of claim 3, wherein the station is a ground station and the antenna points at an elevation of at least 15 degrees while the radio signals are being received via the antenna.

5. The method of claim 3, wherein the station is onboard an aircraft.

6. The method of claim 1, wherein the radio signals are received at the satellite.

7. The method of claim 1, wherein:
the antenna tracks the orbital position of the satellite; and
receiving the radio signals across the frequency band via the antenna comprises receiving the radio signals across the frequency band via the antenna as the antenna tracks the orbital position of the satellite.

8. The method of claim 1, further comprising receiving data at the station from the satellite via the antenna concurrently with receiving the radio signals across the frequency band via the antenna.

9. The method of claim 1, further comprising uploading the generated frequency plan to the satellite.

10. The method of claim 9, wherein uploading the generated frequency plan to the satellite comprises uploading the generated frequency plan to the satellite via the station or another station.

11. The method of claim 1, further comprising:
determining an occupied portion of the frequency band by time and/or orbital position of the satellite based on the spectral measurements; and
correlating the determined occupied portion of the frequency band by time and/or orbital position with license information, wherein the license information indicates one or more portions of the frequency band licensed to one or more operators.

12. The method of claim 1, wherein:
the spectral measurements comprise measured signal strength, power, and/or energy across the frequency band; and
determining the unoccupied portion of the frequency band by time and/or orbital position of the satellite based on the spectral measurements comprises:
comparing the measured signal strength, power, and/or energy across the frequency band with a threshold; and
determining the unoccupied portion of the frequency band by time and/or orbital position of the satellite based on the comparison.

13. The method of claim 12, wherein determining the unoccupied portion of the frequency band by time and/or orbital position of the satellite based on the comparison comprises determining a portion of the frequency band within which the signal strength, power, and/or energy across the frequency band is below the threshold.

14. The method of claim 1, further comprising:
determining a data bandwidth based on a client order; and
determining a frequency bandwidth that supports the determined data bandwidth, wherein allocating the portion of the frequency band for the link between the satellite and the station by time and/or orbital position of the satellite is based also on the determined frequency bandwidth.

15. A system, comprising:
a receiver configured to receive radio signals across a frequency band via an antenna;
a spectral analyzer configured to perform spectral measurements on the received radio signals; and
a resource manager configured to:
determine an unoccupied portion of the frequency band by time and/or orbital position of a satellite based on the spectral measurements;
allocate a portion of the frequency band for a link between the satellite and a station by time and/or orbital position of the satellite based on the determined unoccupied portion of the frequency band by time and/or orbital position of the satellite; and
generate a frequency plan indicating the allocated portion of the frequency band by time and/or orbital position of the satellite.

16. The system of claim 15, further comprising a transmitter configured to transmit the frequency plan to the satellite.

17. The system of claim 15, wherein the resource manager is further configured to:
determine an occupied portion of the frequency band by time and/or orbital position of the satellite based on the spectral measurements; and
correlate the determined occupied portion of the frequency band by time and/or orbital position with license information, wherein the license information indicates one or more portions of the frequency band licensed to one or more operators.

18. The system of claim 15, wherein:
the spectral measurements comprise measured signal strength, power, and/or energy across the frequency band; and
the resource manager is configured to determine the unoccupied portion of the frequency band by time and/or orbital position of the satellite based on the spectral measurements by:
comparing the measured signal strength, power, and/or energy across the frequency band with a threshold; and
determining the unoccupied portion of the frequency band by time and/or orbital position of the satellite based on the comparison.

19. The system of claim 18, wherein determining the unoccupied portion of the frequency band by time and/or orbital position of the satellite based on the comparison comprises determining a portion of the frequency band within which the signal strength, power, and/or energy across the frequency band is below the threshold.

20. The system of claim 15, wherein the resource manager is further configured to:
determine a data bandwidth based on a client order; and
determine a frequency bandwidth that supports the determined data bandwidth, wherein the resource manager is configured to allocate the portion of the frequency band for the link between the satellite and the station by time and/or orbital position of the satellite based also on the determined frequency bandwidth.
